(19) United States
(12) Patent Application Publication
(10) Pub. No.: US 2010/0098828 A1
(43) Pub. Date: Apr. 22, 2010

(54) METHOD AND DEVICE FOR FORMING A FLEXIBLE EDIBLE LAYER

(76) Inventor: Ian Young, South Australia (AU)

Correspondence Address: HAYES SOLOWAY P.C., 3450 E. SUNRISE DRIVE, SUITE 140, TUCSON, AZ, 85718, US

(21) Appl. No.: 12/517,051

(22) PCT Filed: Nov. 29, 2007
(86) PCT No.: PCT/AU07/01843

§ 371 Date: May 29, 2009

(30) Foreign Application Priority Data
Nov. 29, 2006 (AU) 2006906672

(51) Int. Cl. A23P 1/10; A23P 1/00; A23P 1/12; A23C 19/00; B29C 47/92

(52) U.S. Cl. 426/582; 426/517; 426/515; 426/531; 425/141

(57) ABSTRACT

A method for modifying the resilience of a flexible layer having a predetermined footprint and to be formed from a predetermined amount of edible material is described. The method includes increasing the thickness of the flexible layer whilst maintaining the predetermined amount of edible material and the footprint of the flexible layer. In one embodiment, increasing the thickness involves moulding in a flowable form the predetermined amount of edible material in a mould, the mould including a moulding region of substantially the same footprint as the flexible layer with the moulding region including at least one projection extending from the moulding region. The predetermined amount of edible material is then allowed to set.

### PRIORITY

The present application for patent claims priority from Australian Provisional Patent Application No. 2006906672 entitled “METHOD AND DEVICE FOR FORMING A FLEXIBLE LAYER” filed 29 Nov. 2006, which is hereby incorporated by reference herein in its entirety.

### TECHNICAL FIELD

The present invention relates to the preparation of foodstuffs. In a particular form the present invention relates to the preparation of a moulded flexible layer of edible material such as cheese.

### BACKGROUND

The ability to obtain freshly prepared and cooked food in a “fast food” format is readily appreciated by consumers due to the convenience it provides, especially for those having limited time. As such, food preparation techniques have been developed over a period to satisfy this market. These techniques often involve the use of pre-packaged or preformed ingredients which can be rapidly combined with other constituent items to form the final food product.

One such example is the preparation of a pizza where preformed cheese layer portions are used. Typically, four quarter sized portions are laid upon a pizza base as this arrangement provides the correct amount of cheese. The size of these cheese layer portions are such that they do not tear or deform during handling, which would be the case if a single flexible circular cheese layer was employed. This lack of resilience of an extended cheese layer is due to the material properties of cheese which, whilst tending to be naturally flexible, is also prone to tearing or other damage when in the form of a thin layer. This lack of resilience is also common to other foodstuffs which are able to be formed as a flexible layer.

Clearly, having to use multiple portions, whether it is with respect to the preparation of pizza or other food items, results in added inconvenience and time delay due to the extra handling by the person preparing the food item. Furthermore, the use of multiple portions adds extra expense to the food item as each of the portions must be individually manufactured and packaged.

### SUMMARY

In a first aspect the present invention accordingly provides a method for modifying the resilience of a flexible layer having a predetermined footprint and to be formed from a predetermined amount of edible material, the method including increasing the thickness of the flexible layer whilst maintaining the predetermined amount of edible material and the footprint of the flexible layer.

Preferably, the step of increasing the thickness of the flexible layer includes:
moulding in a flowable form the predetermined amount of edible material in a mould, the mould including a moulding region of substantially the same footprint as the flexible layer, the moulding region including at least one projection extending from the moulding region; and
allowing the predetermined amount of edible material to set.

Preferably, the at least one projection extends from a base region of the moulding region.

Preferably, the at least one projection includes a plurality of regularly spaced projections extending from the base region of the moulding region.

Preferably, the plurality of regularly spaced projections form corresponding channels through the flexible layer of edible material.

Optionally, the plurality of regularly spaced projections form corresponding recesses in the flexible layer of edible material.

Optionally, the at least one projection extends from a side region of the moulding region.

Preferably, the moulding region is deployed on at least one rotating drum, the rotating drum functioning to mould the flexible layer.

Preferably, the method further includes cooling the moulding region to facilitate the setting of the predetermined amount of edible material.

Optionally, the step of increasing the thickness of the flexible layer includes:
pressing in a flowable form the predetermined amount of edible material using a press, the press including a pressing region of substantially the same footprint as the flexible layer, the pressing region including at least one projection extending from the pressing region; and
allowing the predetermined amount of edible material to set.

Preferably, the method further includes the step of constraining the boundary of the predetermined amount of edible material during the pressing.

Preferably, the method further includes the step of cooling the predetermined amount of edible material to facilitate setting.

Optionally, the step of increasing the thickness of the flexible layer includes:
extruding in a flowable form edible material through an extruder, the extruder having a sectional profile of substantially the same footprint as the flexible layer, the extruder further including at least one channel forming member to form a channel in the material as it is extruded;
allowing the edible material to set to form set extruded edible material; and
separating the predetermined amount of edible material as a layer from the set extruded edible material.

Preferably, the step of allowing the edible material to set occurs in an outlet region of the extruder.

Preferably, the step of separating the flexible layer includes slicing a sectional slice through the set extruded edible material as it exits the outlet region of the extruder.

Optionally, the step of increasing the thickness of the flexible layer for a predetermined amount of material includes:
depositing multiple amounts of a flowable form of the material within an area having substantially the same footprint as the flexible layer, the sum of the multiple amounts equal to the predetermined amount of material, and
allowing the multiple amounts to flow together and set to form the flexible layer.

Preferably, the method further includes the step of constraining the boundary of the predetermined amount of edible material during the depositing.

In a second aspect the present invention accordingly provides a moulded flexible layer of edible material made in accordance with the method in accordance with the first aspect of the present invention.

Preferably, the edible material is cheese.

In a third aspect the present invention accordingly provides a device for modifying the resilience of a flexible layer having a predetermined footprint and to be formed from a predetermined amount of edible material, the device including thickness increasing means for increasing the thickness of the flexible layer whilst maintaining the predetermined amount of edible material and the footprint of the flexible layer.

Preferably, the thickness increasing means includes a moulding region to mould in a flowable form the predetermined amount of edible material, the moulding region of substantially the same footprint as the flexible layer and including at least one projection extending from the moulding region.

Preferably, the thickness increasing means includes a press to press in a flowable form the predetermined amount of edible material, the press including a pressing region of substantially the same footprint as the flexible layer, the pressing region including at least one projection extending from the pressing region.

Preferably, the thickness increasing means includes:
an extruder for extruding in a flowable form the edible material, the extruder having a sectional profile of substantially the same footprint as the flexible layer, the extruder further including at least one channel forming member to form a channel in the material as it is extruded and allowed to set; and
a separator for separating the predetermined amount of edible material as a layer from the set extruded edible material.

Preferably, the thickness increasing means includes:
a depositer for depositing multiple amounts of a flowable form of the material within an area having substantially the same footprint as the flexible layer, the sum of the multiple amounts equal to the predetermined amount of material to allow the multiple amounts to flow together and set to form the flexible layer.

### BRIEF DESCRIPTION OF THE DRAWINGS

Illustrative embodiments of the present invention will be discussed with reference to the accompanying drawings wherein:

FIG. 1 is a top perspective view of a mould for modifying the resilience of a flexible layer of edible material in accordance with a first illustrative embodiment of the present invention;

FIG. 2 is a top perspective view of a flexible layer of cheese formed from the mould illustrated in FIG. 1;

FIG. 3 is a top view of a mould for modifying the resilience of a flexible layer of edible material in accordance with a second illustrative embodiment of the present invention;

FIG. 4 is a top view of a system for modifying the resilience of a flexible layer of edible material in accordance with a third illustrative embodiment of the present invention;

FIG. 5 is a perspective view of a system for modifying the resilience of a flexible layer of edible material in accordance with a fourth illustrative embodiment of the present invention;

FIG. 6 is a side view of a system for modifying the resilience of a flexible layer of edible material in accordance with a fifth illustrative embodiment of the present invention;

FIG. 7 is a side view of a system for modifying the resilience of a flexible layer of edible material in accordance with a sixth illustrative embodiment of the present invention; and

FIG. 8 is a side view of a system for modifying the resilience of a flexible layer of edible material in accordance with a seventh illustrative embodiment of the present invention.

In the following description, like reference characters designate like or corresponding parts throughout the several views of the drawings.

### DESCRIPTION

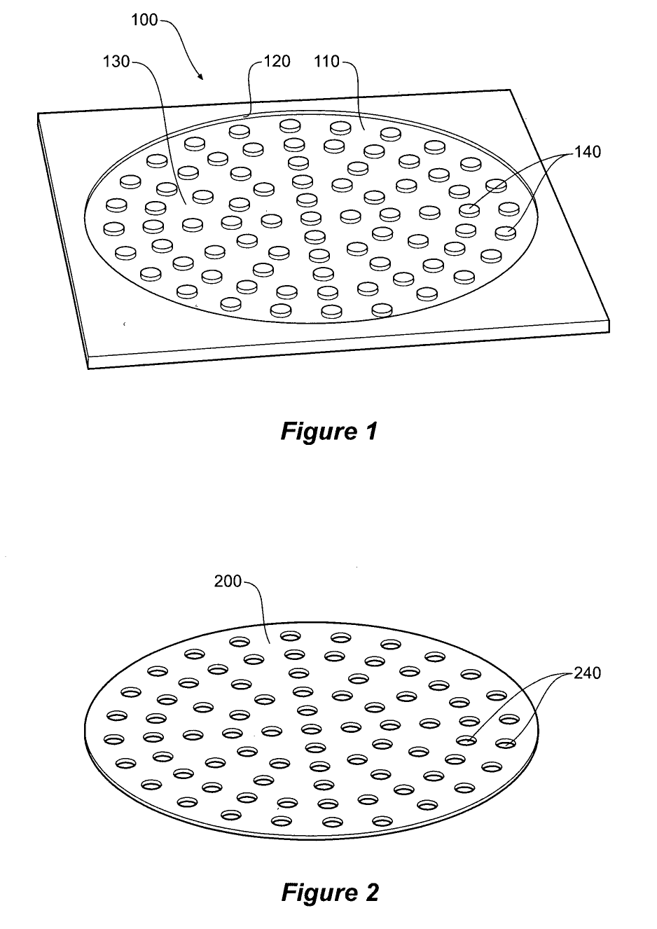

Referring now to FIG. 1, there is shown a mould 100 for forming a 250 mm diameter piece of cheese with a target weight of 130 grams. As would be apparent to those skilled in the art, a layer of cheese weighing this amount and cast in accordance with prior art methods would be very thin and hard to handle. Accordingly, such a layer of cheese would not be conducive to the rapid preparation of a pizza such as would be required for a pizza delivery service or the like.

Mould 100 includes a base region 110 and side region 120 forming a disc shaped moulding region 130 having an overall diameter of 250 mm. Extending from base region 110 of mould 100 are 77×10 mm cylindrical shaped projections 140.

The moulding process involves filling moulding region 130 with cheese in fluid or flowable form or alternatively by melting a cheese billet into moulding region 130 and casting the liquid at a temperature of approximately 65° C. In this process the cheese will fill moulding region 130 and eventually set.

Referring now to FIG. 2, there is shown the resultant flexible layer of cheese 200 after the moulding process where cheese layer 200 has set. Cheese layer 200 shares the same footprint as moulding region 130 and includes a series of 77 regularly spaced channels or perforations 240 which correspond to the 77 cylindrical shaped projections 140 of mould 100. In this illustrative embodiment, cheese layer 200 is approximately 2 mm thick which, as would be apparent to those skilled in the art, will be sufficiently thick for easy handling as a unitary layer of cheese suitable to be placed on a 250 mm pizza base due to its increased resilience.

When the cheese layer 200 melts during the cooking of the pizza, the regularly spaced channels 240 will fill as the cheese melts, eventually closing up and resulting in a circular disc of cheese on the final finished pizza. In another illustrative embodiment of the present invention, the projections may extend only partially into the moulded flexible layer of cheese, thereby forming a series of recesses, indentations or cavities in the flexible layer of edible material.

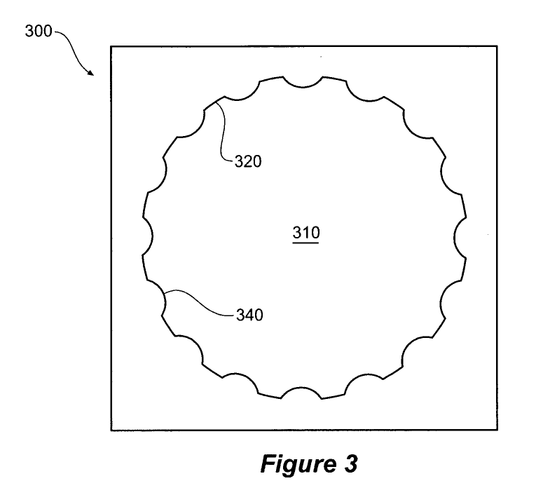

Referring now to FIG. 3, there is shown a mould 300 for forming a 250 mm diameter piece of cheese with a target weight of 130 grams as in the previous embodiment. In this embodiment, the projections 340 extend from the side region 320 of mould 300 into base region 310, effectively forming cut-away or scalloped portions in the periphery of the moulded flexible layer of cheese. Once again, when the cheese melts during the cooking of the pizza, these cut away portions in the periphery will be substantially filled in, resulting in a circular disc of cheese on the final finished pizza.

As would be apparent to those skilled in the art, the shape, size and location of the projection or projections is not important as long as it performs the function of increasing the thickness of the resultant moulded flexible layer of edible material whilst substantially maintaining the footprint.

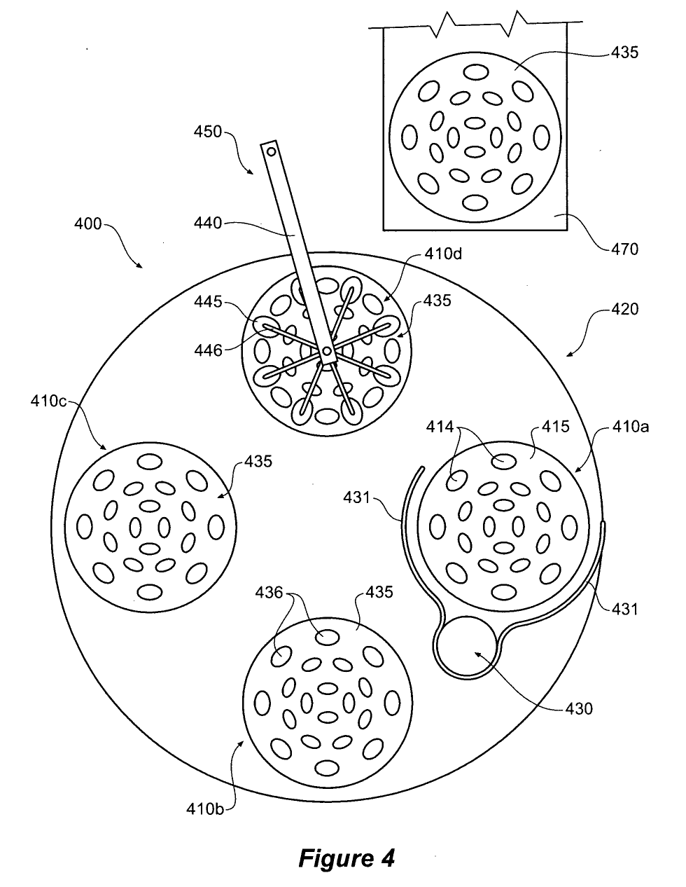

Referring now to FIG. 4, there is shown a top view of a system 400 for modifying the resilience of a flexible layer of edible material according to a third illustrative embodiment of the present invention. System 400 includes a rotating table or carousel 420 comprising four stations 410a, 410b, 410c, 410d each consisting of a moulding region 415 as has been previously described above and in this embodiment including a series of projections 414 which protrude from the base of the moulding region 415.

At first station 410a, melted, or more generally, flowable cheese 430 is pumped from feed outlet 430 and screeded or directed by guide members 431 to the moulding region 415 to form a layer. Stations 410b and 410c are setting stations whereby the flowable cheese sets to form a cheese layer 435 having channels or perforations 436 corresponding to projections 414. Similarly, for smaller sized projections 414 then corresponding indentations will be formed in the bottom surface of cheese layer 435.

In this illustrative embodiment, rotating table 420 is chilled to facilitate the setting process. At station 410d, the flexible cheese layer 435 is transferred to conveyor 470 to be transported to packaging by a vacuum pick and place system 450. This system consists of a swinging arm 440 having at its end a series of radial members 446. Each of the radial members includes respectively at its end a suction head 445 operable to pick up cheese layer 435 from station 410d by employing suction pressure. The suction pressure is then turned off once the cheese layer 435 is transferred over to the conveyor 470 by arm 440. Once cheese layer 435 is removed at station 410d, table 420 rotates to station 410a and moulding region 415 is once again supplied by feed outlet 430.

As would be appreciated by those skilled in the art, the number of stations may be varied according to manufacturing requirements such as required throughput and the like.

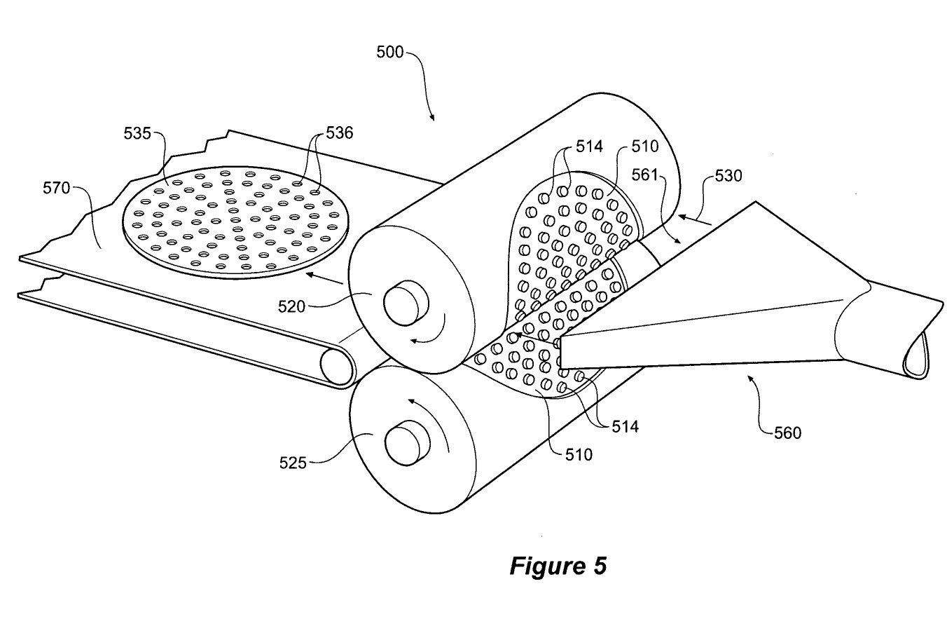

Referring now to FIG. 5, there is shown a perspective view of a system 500 for modifying the resilience of a flexible layer of edible material according to a fourth illustrative embodiment of the present invention. In this illustrative embodiment, flowable cheese 530 is extruded from elongate slot 561 (which is generally of the same width as the resultant cheese layer 535) of feed outlet 560 and fed between a pair of chilled rotating forming drums 520, 525 each having opposed moulding regions 510 having matched projections 514. Drums 520, 525 function to press out or mould a cheese layer 535 having the desired footprint onto conveyor 570 where cheese layer 535 is then allowed to further set. Depending on the size of the projections 514, either perforations or channels 536 (as shown here) or indentations may be formed in the cheese layer 535.

Drums 520, 525 may be swapped out with alternative drums incorporating moulding regions of a different size and profile to form cheese layers having a different footprint. Although, in this embodiment, both drums 520, 525 have opposed corresponding moulding regions 510, equally one of the drums may have a smooth uniform surface and the other drum incorporate the entire moulding region.

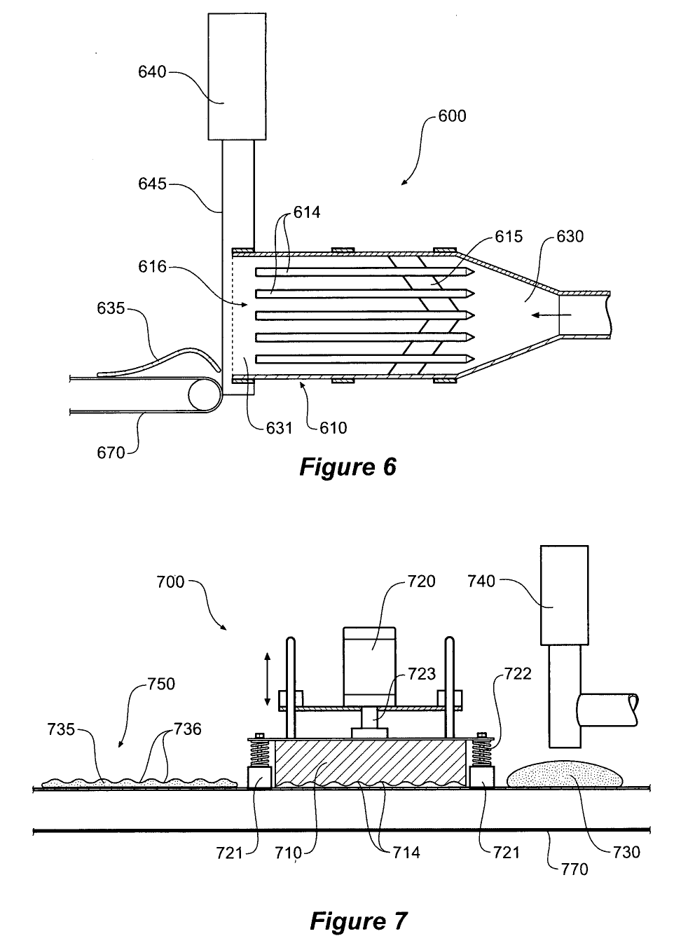

Referring now to FIG. 6, there is shown a side view of a system 600 for modifying the resilience of a flexible layer of edible material according to a fifth illustrative embodiment of the present invention. System 600 includes a generally cylindrical extrusion head or extruder 610 incorporating a plurality of horizontal channel forming members 614, suspended by a suspension framework 615, and uniformly spaced throughout the extrusion head 610 and a slicing apparatus 640. Flowable cheese 630 is forced through extrusion head 610 and passes through and past suspension framework 615 in the process forming an extruded cylinder 631 of the flowable cheese that gradually sets in an outlet region 616 of extruder 610 and which now incorporates a plurality of channels corresponding to the location of channel forming members 614.

Slicing apparatus 640 includes a vertically actuated blade 645 which functions to cut or slice a sectional slice through the extruded cylinder 631 of extruded cheese as it exits extrusion head 610, in the process forming a cheese layer 635 of predetermined thickness which falls onto conveyor 670 to be transported for packaging. As would be apparent to those skilled in the art, the thickness of the predetermined layer may be varied by changing the flow rate of the flowable cheese 630 and/or the cutting rate of slicing apparatus 640.

In another related embodiment, a preformed cheese log or cylinder may be cored or bored out by a drilling apparatus to provide the plurality of channels. The resultant modified cheese cylinder may then be sliced to the required thickness by slicing apparatus 640.

Referring now to FIG. 7, there is shown a side view of a system 700 for modifying the resilience of a flexible layer of edible material according to a sixth illustrative embodiment of the present invention. System 700 incorporates a feed outlet 740 from which flowable cheese 730 is extruded onto a moving chilled conveyer 770 where it is then moulded by pressing station 720 which in this illustrative embodiment includes a vertically actuated mould press 710 having a series of projections 714. When the predetermined amount of flowable cheese 730 is advanced to pressing station 720 by conveyor 770 a circular forming ring 721 is first deployed downwards to provide an outer boundary for the formed cheese layer 735 thereby determining the resultant footprint of cheese layer 735. Mould press 710 is then deployed downwards by pneumatic ram 723 acting against vertically oriented biasing springs 722 that extend from circular forming ring 721 thereby forming cheese layer 735 having a series of perforations or indentations 736 that correspond to projections 714.

After the pressing stage, mould press 710 is then raised and the circular forming ring 721 momentarily stays in place by virtue of biasing springs 722 before also being raised. Cheese layer 735 is then allowed to set at which stage it can be removed by a vacuum pick and place system 750 such as that referred to in FIG. 4.

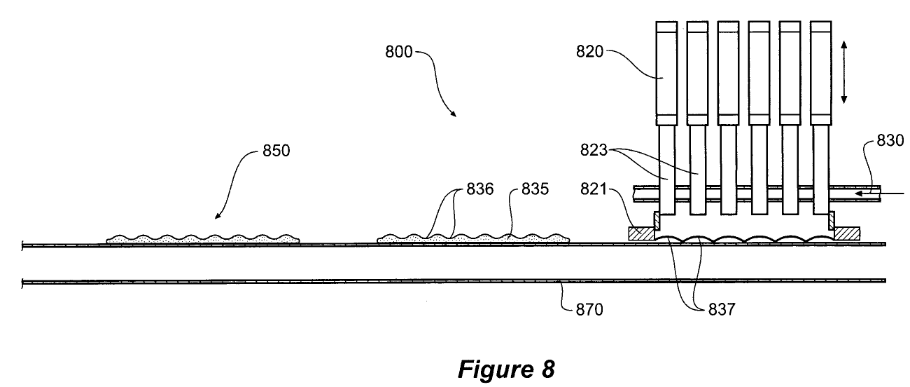

Referring now to FIG. 8, there is shown a side view of a system 800 for modifying the resilience of a flexible layer of edible material in accordance with a seventh illustrative embodiment of the present invention. System 800 includes a deposit head 820 comprising multiple vertically oriented feed heads 823 having as their input flowable cheese 830. Feed heads 823 function to deposit multiple individual amounts of regularly spaced flowable cheese 837 located within circular forming ring 821 onto chilled conveyor 870, thereby determining the footprint of resultant cheese layer 835. The multiple amounts of flowable cheese 837 will partially flow and run together and then set forming indentations and/or channels or perforations 836 in the cheese layer 835 corresponding to those locations where the cheese was not deposited.

Circular forming ring 821 is then removed and flexible cheese layer 835 is advanced along chilled conveyor 870 where it will further set and then can be removed by a vacuum pick and place system 850 such as that referred to in FIG. 4.

Flowable cheese or more generally edible material in a flowable form may comprise material that has been heated or melted or alternatively be in granular or particulate form and made flowable by the application of suitable pressure such as in a pressing, moulding or extrusion process such as has been described previously.

As would be appreciated by those skilled in the art, the cheese layers formed by the thickness increasing means referred to in the illustrative embodiments will be correspondingly thicker and hence more resilient than those layers that consist of the same amount of material without the channels, indentations or perforations, thereby increasing the resilience and handling properties of the flexible cheese layer.

Whilst the present invention has been described in relation to the formation of a cheese layer, it will be appreciated that the invention will have other applications consistent with the principles described in the specification and that it can be generally directed to the formation of any moulded flexible layer of edible material. Some other examples include the formation of cheese layers having other food products in particulate form such as ham or bacon integrated within the cheese layer.

Additionally, in another illustrative embodiment the flexible layer may be formed of a gelatinous material which is moulded by initially cooling a heated liquid or flowable form of the gelatinous material. The resultant flexible layer of edible material formed in accordance with the present invention will have an increased thickness and hence resilience when compared to flexible layer formed using prior art methods. This gelatinous material may then be further heated resulting in the gelatinous material evenly spreading over or through a base layer as is required.

A brief consideration of the above described embodiments will indicate that the invention provides an extremely simple, economical feature for increasing the resilience of a moulded flexible layer of edible material of a required footprint which is effective to significantly reduce the handling difficulties involved in the preparation of food items incorporating the flexible layer.

Although illustrative embodiments of the present invention have been described in the foregoing detailed description, it will be understood that the invention is not limited to the embodiments disclosed, but is capable of numerous rearrangements, modifications and substitutions without departing from the scope of the invention as set forth and defined by the following claims.

1. A method for modifying the resilience of a flexible layer having a predetermined footprint and to be formed from a predetermined amount of edible material, the method including increasing the thickness of the flexible layer whilst maintaining the predetermined amount of edible material and the footprint of the flexible layer.

2. The method as claimed in claim 1, wherein the step of increasing the thickness of the flexible layer includes:
moulding in a flowable form the predetermined amount of edible material in a mould, the mould including a moulding region of substantially the same footprint as the flexible layer, the moulding region including at least one projection extending from the moulding region; and
allowing the predetermined amount of edible material to set.

3. The method as claimed in claim 2, wherein the at least one projection extends from a base region of the moulding region.

4. The method as claimed in claim 3, wherein the at least one projection includes a plurality of regularly spaced projections extending from the base region of the moulding region.

5. The method as claimed in claim 4, wherein the plurality of regularly spaced projections form corresponding channels through the flexible layer of edible material.

6. The method as claimed in claim 4, wherein the plurality of regularly spaced projections form corresponding recesses in the flexible layer of edible material.

7. The method as claimed in claim 1, wherein the at least one projection extends from a side region of the moulding region.

8. The method of claim 1 anyone of the preceding claims, wherein the moulding region is deployed on at least one rotating drum, the rotating drum functioning to mould the flexible layer.

9. The method of claim further including cooling the moulding region to facilitate the setting of the predetermined amount of edible material.

10. The method as claimed in claim 1, wherein the step of increasing the thickness of the flexible layer includes:
pressing in a flow able form the predetermined amount of edible material using a press, the press including a pressing region of substantially the same footprint as the flexible layer, the pressing region including at least one projection extending from the pressing region; and
allowing the predetermined amount of edible material to set.

11. The method as claimed in claim 10, further including the step of constraining the boundary of the predetermined amount of edible material during the pressing.

12. The method as claimed in claim 10, further including the step of cooling the predetermined amount of edible material to facilitate setting.

13. The method as claimed in claim 1, wherein the step of increasing the thickness of the flexible layer includes:
extruding in a flowable form edible material through an extruder, the extruder having a sectional profile of substantially the same footprint as the flexible layer, the extruder further including at least one channel forming member to form a channel in the material as it is extruded:
allowing the edible material to set to form set extruded edible material; and
separating the predetermined amount of edible material as a layer from the set extruded edible material.

14. The method as claimed in claim 13, wherein the step of allowing the edible material to set occurs in an outlet region of the extruder.

15. The method as claimed in claim 14, wherein the step of separating the flexible layer includes slicing a sectional slice through the set extruded edible material as it exits the outlet region of the extruder.

16. The method as claimed in claim 1, wherein the step of increasing the thickness of the flexible layer for a predetermined amount of material includes:
depositing multiple amounts of a flowable form of the material within an area having substantially the same footprint as the flexible layer, the sum of the multiple amounts equal to the predetermined amount of material; and
allowing the multiple amounts to flow together and set to form the flexible layer.

17. The method as claimed in claim 16, further including the step of constraining the boundary of the predetermined amount of edible material during the depositing.

18. A moulded flexible layer of edible material made in accordance with the method of claim 1.

19. A moulded flexible layer of edible material as claimed in claim 18, wherein the edible material is cheese.

20. A device for modifying the resilience of a flexible layer having a predetermined footprint and to be formed from a predetermined amount of edible material, the device including a thickness increasing device for increasing the thickness of the flexible layer whilst maintaining the predetermined amount of edible material and the footprint of the flexible layer.

21. The device as claimed in claim 20, wherein the thickness increasing device includes a moulding region to mould in a flowable form the predetermined amount of edible material the moulding region of substantially the same footprint as the flexible layer and including at least one projection extending from the moulding region.

22. The device as claimed in claim 20, wherein the thickness increasing device includes a press to press in a flowable form the predetermined amount of edible material, the press including a pressing region of substantially the same footprint as the flexible layer, the pressing region including at least one projection extending from the pressing region.

23. The device as claimed in claim 20, wherein the thickness increasing device includes:
an extruder for extruding in a flowable form the edible material, the extruder having a sectional profile of substantially the same footprint as the flexible layer, the extruder further including at least one channel forming member to form a channel in the material as it is extruded and allowed to set; and
a separator for separating the predetermined amount of edible material as a layer from the set extruded edible material.

24. The device as claimed in claim 20, wherein the thickness increasing device includes:
a depositor for depositing multiple amounts of a flow able form of the material within an area having substantially the same footprint as the flexible layer, the sum of the multiple amounts equal to the predetermined amount of material to allow the multiple amounts to flow together and set to form the flexible layer.

25. The method as claimed in claim 11, further including the step of cooling the predetermined amount of edible material to facilitate setting.

26. A moulded flexible layer of edible material made in accordance with the method of claim 25.
